(19) United States
(12) Patent Application Publication
(10) Pub. No.: US 2007/0118566 A1
(43) Pub. Date: May 24, 2007

(54) Method and Apparatus for File Attribute Selection into a System Clipboard

(75) Inventors: Oscar J. Blass, Boynton Beach, FL (US); Brennan Monteiro, Boca Raton, FL (US); Roberto Vila, Hollywood, FL (US)

Correspondence Address: CUENOT & FORSYTHE, L.L.C., 12230 FOREST HILL BLVD., STE. 120, WELLINGTON, FL, 33414, US

(73) Assignee: INTERNATIONAL BUSINESS MACHINES CORPORATION, Armonk, NY (US)

(21) Appl. No.: 11/164,342

(22) Filed: Nov. 18, 2005

(51) Int. Cl. G06F 17/30

(52) U.S. Cl. 707/200

(57) ABSTRACT

A method of selectively pasting attributes of files can include, responsive to a user input, storing each selected file and at least one attribute associated with each selected file. Responsive to a subsequent input, a target object can be identified and either the attribute associated with each selected file can be inserted into the target object or a copy of each selected file can be created within the target object according to whether the target object supports file object types.

### FIELD OF THE INVENTION

The present invention relates to copying attributes of files and inserting such attributes into objects.

### DESCRIPTION OF THE RELATED ART

Software developers frequently find themselves compiling lists of files. For example, it often is the case that a list of files is needed to produce one or more scripts that relate to the files on the list. In another example, the list of files may be required by a software development tool, such as a source code control system, which takes some action upon the files specified in the list. In any case, lists of files often serve as input to various software development tools.

Presently, software developers manually compile these file lists. For instance, if a list of files is already in existence, a developer can copy various filenames from the list and paste the selected filenames into a destination, i.e. a text field of a software development tool. In other cases, where no list is in existence, developers open a command shell, run a set of tedious scripts to compile a list of files into a text file, manually open the text file, run the copy command, open the target into which the filenames are to be inserted, and finally paste the list of filenames into the target.

In either case, the process of manually compiling a list of filenames can be long, tedious, and error prone, particularly in light of the many files that often are to be included in such a list. It would be beneficial to provide a technique that obtains one or more file attributes and provides those attributes to a destination object that overcomes the limitations described above.

### SUMMARY OF THE INVENTION

The embodiments disclosed herein provide methods and apparatus for obtaining one or more attributes of files and including those attributes within a destination, or target, object. One embodiment of the present invention can include a method of selectively pasting attributes of files. The method can include, responsive to a user input, storing each selected file and at least one attribute associated with each selected file. Responsive to a subsequent user input, a target object can be identified. Also responsive to the subsequent user input, the method can include selectively inserting the attribute associated with each selected file into the target object or creating a copy of each selected file within the target object according to whether the target object supports file object types.

Another embodiment of the present invention can include a method of pasting attributes of files. The method can include, responsive to a user input, storing at least one attribute of each selected file. Responsive to a subsequent user input, the attribute of each selected file can be inserted into a target object that does not support file object types.

Yet another embodiment of the present invention can include a machine readable storage, having stored thereon a computer program having a plurality of code sections for causing a machine to perform the various steps and implement the components and/or structures disclosed herein.

### BRIEF DESCRIPTION OF THE DRAWINGS

There are shown in the drawings, embodiments which are presently preferred; it being understood, however, that the invention is not limited to the precise arrangements and instrumentalities shown.

FIG. 1 is a view of a graphical user interface (GUI) which can be used to select files in accordance with one aspect of the present invention.

FIG. 2 is a view of the GUI of FIG. 1 in which the files have been reordered.

FIG. 3 is a view of a GUI which includes objects that do not support file object types in accordance with another aspect of the present invention.

FIG. 4 is a view of a drop down menu illustrating another aspect of the present invention.

FIG. 5 is a flow chart illustrating a method of file attribute selection in accordance with yet another aspect of the present invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

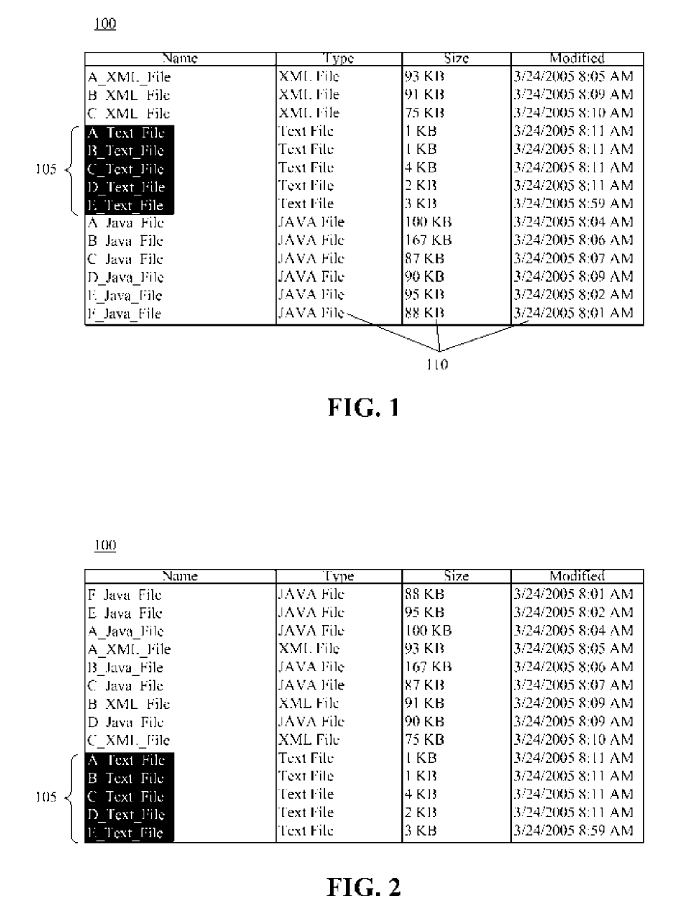

FIG. 1 is a view of a graphical user interface (GUI) 100 which can be used to select files in accordance with one aspect of the present invention. As shown, GUI 100 presents a listing of files in a given location on a computer system. One or more attributes 110 corresponding to each displayed file also can be shown, i.e. the file type, size, and/or the date and/or time the file was last modified. Other attributes also can be displayed, though not shown, such as the date and/or time the file was created or any other parameter of a file that is tracked and/or maintained by the operating system of a computer or other information processing system.

As shown, five files 105 have been selected in GUI 100. The names of the selected files 105 are “A_Text_File”, “B_Text_File”, “C_Text_File”, “D_Text_File”, and “E_Text_File”. Each of the selected files 105 is a text file. Typically, once one or more files are selected, a conventional cut and paste or copy paste operation can be performed. A traditional cut or copy/paste operation places a copy of the selected files 105 into temporary storage of a computer system, often referred to as the clipboard. The entirety of the selected files 105 then can be pasted into a target location that is selected by a user. That is, a copy of each selected file 105 is created or inserted at the location designated by the user.

In accordance with one embodiment of the present invention, rather than placing a copy of the entire selected file in temporary storage, responsive to a copy command from a user, a copy of the selected file(s) as well as a copy of one or more of the attributes of the selected file(s) can be placed into temporary storage. Subsequently, one or more of the attributes of the selected files 105 can be pasted, or copied, from the temporary storage into the target location. For example, in one embodiment, the name of each file can be pasted into the target location. Thus, the text “A_Text_File, B_Text_File, C_Text_File, D_Text_File, E_Text_File”, corresponding to the filename of each selected file, can be pasted into the target location. Any appropriate delimiter, if one is needed or desired, can be inserted between the respective filenames.

FIG. 2 is a view of the GUI of FIG. 1 in which the files have been reordered. As shown, the files have been reordered according to the date and time modified, with the most recently modified files being displayed toward the bottom of the list. As was the case with FIG. 1, five files 105 still are selected, or have been selected, as the case may be. FIG. 2 illustrates that the files can be sorted in ascending or descending order according to any of a variety of different attributes that are tracked by an operating system, thereby allowing a developer to more easily select the desired files 105.

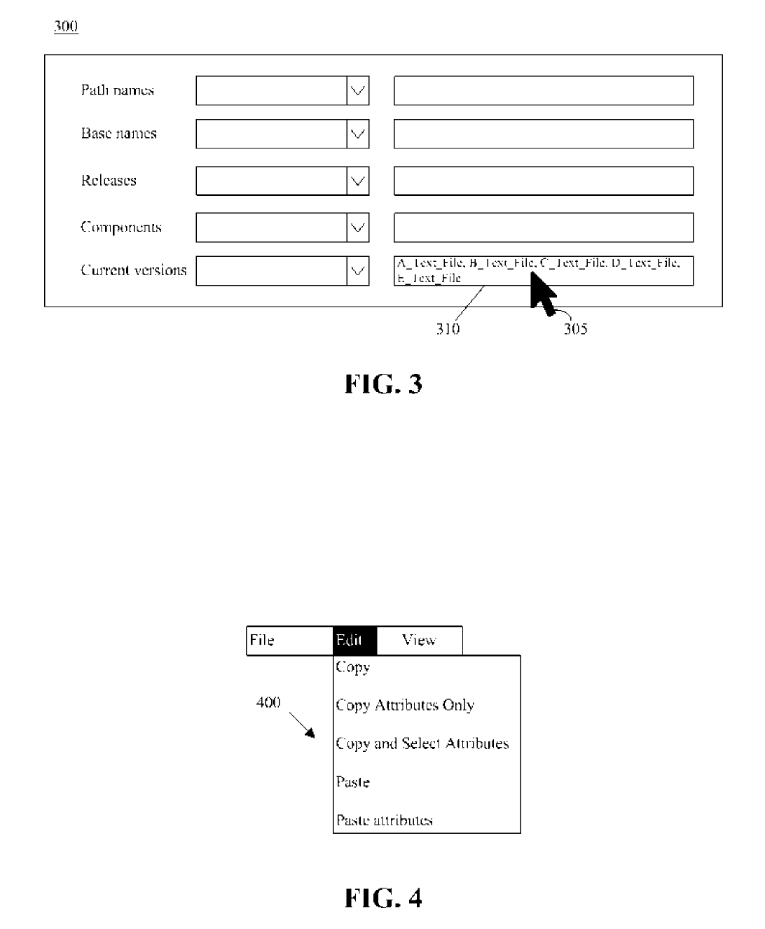

FIG. 3 is a view of a GUI 300 which includes objects that do not support file object types in accordance with another aspect of the present invention. Once a copy command has been executed and a copy of each selected file and the attributes of that file have been placed into temporary storage, the user can select a target location to which information can be pasted. In accordance with one embodiment of the present invention, if the target location supports file object types, a copy of each selected file can be placed or copied into the target location. If, however, the target location does not support file object types, then the attribute(s) of the selected file(s) can be copied into the target location.

As shown in FIG. 3, the pointer 305 is proximate to, or has been placed over text field 310, such that text field 310 has been selected as the target location for a paste operation. The text field 310 can only receive text as input. That is, text field 310 does not support file object types. Accordingly, when the paste operation is invoked with text field 310 having been selected as the target location, one or more attributes of the selected file(s) can be pasted into text field 310, such as the filenames of the selected files illustrated in FIGS. 1 and 2.

FIG. 4 is a view of a drop down menu 400 illustrating another aspect of the present invention. As shown, the menu 400 includes a plurality of different user-selectable menu items. Within the selections are several different cut and paste options. For example, copy and paste menu items can be provided which can function substantially as described herein. A “Copy with Attributes Only” menu item also has been provided which copies only attributes of the selected file(s) and not the file(s) themselves. It should be appreciated that the user can set defaults as to which file attributes, i.e. the filename, date created, etc., are copied and pasted by default. Further, a default delimiter, if any, can be specified.

A “Copy and Select Attributes” menu item can be provided as well. This menu item can cause a further dialog or GUI (not shown) to be presented to the user that allows the user to specify exactly which attributes of the selected file(s) are to be copied into temporary storage. A similar functionality can be provided regarding a paste function. That is, if all attributes of selected file(s) are copied, a paste special type of function can be provided which allows the user to select which attributes are pasted.

The particular copy/paste options described with reference to FIG. 4 are presented to further illustrate various embodiments of the present invention. The examples described, however, are not intended to limit the present invention, but rather to show the combinations of attribute selection and pasting that can be performed.

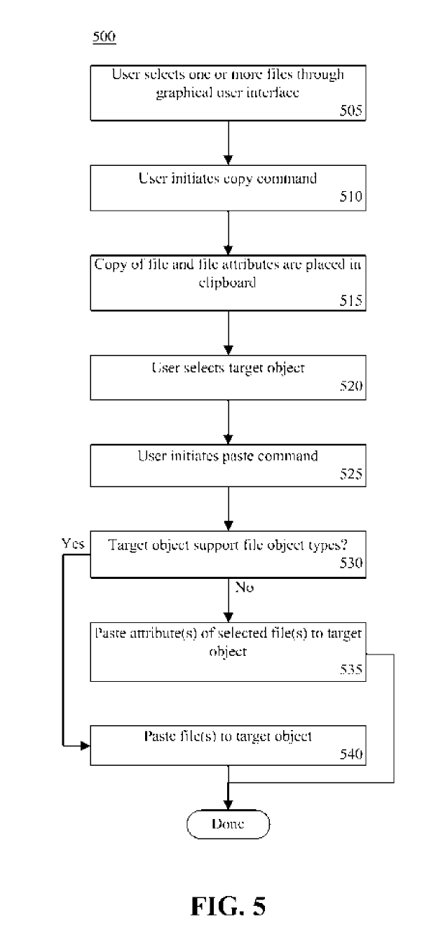

FIG. 5 is a flow chart illustrating a method 500 of file attribute selection in accordance with another aspect of the present invention. The method 500 can begin in step 505 where a user selects one or more files using a GUI or some other means of file selection. In step 510, the user can initiate a copy command. Accordingly, depending upon the particular type of copy command requested, a copy of the selected file(s) and the attribute(s) associated with each selected file can be placed into temporary storage in step 515. It should be appreciated that the manner in which the temporary storage functions, i.e. storing in random access memory (RAM), on in a portion of a fixed medium such as a hard disk, or the like, is not intended to limit the present invention in any way. Further, the clipboard need not be implemented using temporary storage, but if desired, can be implemented using persistent storage.

In step 520, the user can select a target location or object. For example, the location in which the pointer or cursor is located can be identified and/or selected. Such an object can be said to be the active object or one with focus. In step 525, the user can initiate a paste command. In step 530, the target object is evaluated to determine whether the target object supports file object types. If so, the method can proceed to step 540 where copies of the actual selected file(s) are placed or created within the target object, or at the target location. That is, the paste operation works as a conventional paste operation. If not, a copy of the attribute(s) of each selected file can be created within the target object in step 535. Text of the attributes, i.e. a filename, date of creation, or the like, as the case may be, can be inserted within the target object.

It should be appreciated that the various GUI's and visual objects disclosed herein have been provided for purposes of illustration only. As such, these items are not intended to limit the present invention in any way, but rather to serve as examples for teaching one skilled in the art various ways in which the embodiments disclosed herein can be implemented.

The inventive arrangements disclosed herein provide away in which one or more parameters of files can be copied and pasted. The embodiments disclosed herein can, if desired, paste either the selected file(s) or one or more attributes of the selected file(s) to the target object according to context, i.e. whether the target object supports file object types. Further, it should be appreciated that the functionality disclosed herein can be implemented within the operating system of a computer and/or information processing system or within an application executing therein.

The present invention can be realized in hardware, software, or a combination of hardware and software. The present invention can be realized in a centralized fashion in one computer system or in a distributed fashion where different elements are spread across several interconnected computer systems. Any kind of computer system or other apparatus adapted for carrying out the methods described herein is suited. A typical combination of hardware and software can be a general-purpose computer system with a computer program that, when being loaded and executed, controls the computer system such that it carries out the methods described herein. The present invention also can be embedded in a computer program product, which comprises all the features enabling the implementation of the methods described herein, and which when loaded in a computer system is able to carry out these methods.

The terms “computer program”, “software”, “application”, variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, a computer program can include, but is not limited to, a subroutine, a function, a procedure, an object method, an object implementation, an executable application, an applet, a servlet, a source code, an object code, a shared library/dynamic load library and/or other sequence of instructions designed for execution on a computer system.

The terms “a” and “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically, i.e. communicatively linked through a communication channel or pathway.

This invention can be embodied in other forms without departing from the spirit or essential attributes thereof. Accordingly, reference should be made to the following claims, rather than to the foregoing specification, as indicating the scope of the invention.

What is claimed is:

1. A method of selectively pasting attributes of files comprising:
responsive to a user input, storing each selected file and at least one attribute associated with each selected file; and
responsive to a subsequent user input, identifying a target object and selectively inserting the attribute associated with each selected file into the target object or creating a copy of each selected file within the target object according to whether the target object supports file object types.

2. The method of claim 1, said method further comprising determining whether the target object supports file object types, and if not, inserting the attribute of each selected file into the target object.

3. The method of claim 2, wherein the at least one attribute is a filename of each selected file.

4. The method of claim 2, wherein the at least one attribute is an attribute for each selected file that is maintained by an operating system.

5. The method of claim 2, wherein the target object is a text field of a graphical user interface.

6. The method of claim 1, said method further comprising determining whether the target object supports file object types, and if so, copying each selected file into the target object.

7. The method of claim 1, further comprising storing only specified attributes of each selected file or inserting only specified attributes of each selected file.

8. A method of pasting attributes of files comprising:
responsive to a user input, storing at least one attribute of each selected file; and
responsive to a subsequent user input, inserting the attribute of each selected file into a target object that does not support file object types.

9. The method of claim 8, said inserting step further comprising:
detecting a location of the pointer;
identifying a target object according to the location of the pointer; and
determining that the target object does not support file object types.

10. The method of claim 9, wherein said storing step further stores each selected file, said inserting step further comprising selectively inserting either at least one attribute for each selected file or a copy of each selected file according to the type of objects the target object supports.

11. The method of claim 9, wherein the target object is a text field disposed within a graphical user interface.

12. The method of claim 8, wherein the at least one attribute is a filename for each selected file.

13. The method of claim 8, wherein the at least one attribute is an attribute that is available in the operating system for each selected file.

14. A machine readable storage having stored thereon a computer program having a plurality of code sections comprising:
code for storing each selected file and at least one attribute associated with each selected file responsive to a user input; and
code for, responsive to a user input, identifying a target object and selectively inserting the attribute associated with each selected file into the target object or creating a copy of each selected file within the target object according to whether the target object supports file object types.

15. The machine readable storage of claim 14, further comprising code for determining whether the target object supports file object types, and if not, inserting the attribute of each selected file into the target object.

16. The machine readable storage of claim 15, wherein the at least one attribute is a filename of each selected file.

17. The machine readable storage of claim 15, wherein the at least one attribute is an attribute for each selected file that is maintained by an operating system.

18. The machine readable storage of claim 15, wherein the target object is a text field of a graphical user interface.

19. The machine readable storage of claim 14, further comprising code for determining whether the target object supports file object types, and if so, copying each selected file into the target object.

20. The machine readable storage of claim 14, further comprising code for storing only specified attributes of each selected file or inserting only specified attributes of each selected file.
